(19) United States
(12) Patent Application Publication
(10) Pub. No.: US 2004/0079291 A1
(43) Pub. Date: Apr. 29, 2004

(54) Apparatus and method for channeling waste from a self-cleaning cat litter box waste holder or tray into a garbage bag or container

(76) Inventor: Henry Francis Romatowski, New Paltz, NY (US)

Correspondence Address: Henry F. Romatowski, 183 Sparkling Ridge Rd., New Paltz, NY, 12561, US

(21) Appl. No.: 10/281,741

(22) Filed: Oct. 28, 2002

(51) Int. Cl. A01K 29/00

(52) U.S. Cl. 119/161

(57) ABSTRACT

An apparatus and method for more efficiently and hygienically managing and disposing waste that is otherwise stored in the holder or tray of a self-cleaning cat litter box is presented. It enables waste to channel into a garbage bag instead of accumulating in a relatively smaller and expensive tray, thereby, reducing the frequency of disposal and maintenance and minimizing unhygienic conditions that occur when waste exceeds tray capacity. It can be shaped in the form of a table, for positioning below said litter box, with it's intake hole positioned below said tray, so that waste falling from a hole in said tray enters and channels into a garbage bag/container positioned across the outflow opening of the apparatus. It may also be shaped to substitute for said holder or tray, with the added element of an outflow opening to which a plastic garbage bag can positioned to receive and store waste.

### BACKGROUND OF THE INVENTION

The present invention relates to the storage and disposal of waste from cat litter boxes, and particularly to an apparatus and method for efficiently and hygienically managing and disposing of waste intended for storage in the waste storage holder or disposable tray of a self-cleaning cat litter box.

Prior art includes various devices, methods and systems that reduce the work associated with cleaning cat litter boxes. One system comprises a hand held scoop shovel and a plastic bag holder to hold garbage bags into which scooped up waste may be deposited for later disposal. Still other prior art includes self-cleaning litter boxes that self-rake and scoop waste from the litter bed and transfer it to a component waste holder or tray. One such self-cleaning litter box, presently in wide popular use, stores waste in a single disposable tray held in a bottomless cavity on one side of the box's litter area.

Because self-cleaning or self-raking litter boxes of the type described use clumping cat litter that adheres to both solid and liquid waste, the volume of combined cat and litter waste entering said canister is significantly greater the volume of fecal/urine waste produced by the cat.

The mentioned self-cleaning box presently in wide popular use holds waste in a single disposable tray that is approximately only 0.12 cubic feet in volume. Consequently the tray can fill and overflow in as little as three days, or even less if used by more than one cat. Also its replacement trays sell for as much $1.20 each—a significant cost compared to $0.05 cost of larger commonly available plastic garbage bags.

Said tray is also made of flexible plastic and has a lip edge that inserts behind tabs on the surrounding box frame. Should waste fill or overflow the tray before the user realizes it is full, waste can become compacted around the tray's lip edge and surrounding tab area. Then unlocking and flexing the tray for disposal could cause its edge to snap and catapult said waste into the immediate environment, including the face of the person removing the tray. The process of cleaning such compacted waste with a small supplied brush can also catapult waste into the surrounding environment. Waste can also stick to the brush. Thereby the person doing the cleaning can a face undersireable contact with waste material and unanticipated back bending work, as said box is typically kept on the floor.

### BRIEF SUMMARY OF THE INVENTION

It is the object of the present invention to solve the several described problems associated with prior art and some popular self-cleaning litter boxes having component waste holders or trays, by providing an apparatus and method to easily channel waste directly into a larger container such as an ordinary plastic garbage bag instead of the relatively small capacity holder or tray and methods used by said boxes and prior art.

It is the further object of the invention to solve said problems by providing an easy to use accessory apparatus and method, for use with suitable self-cleaning litter boxes and those as are presently is wide popular use, that facilitates more efficient and hygienic management and disposal of waste and does so in a manner:

(1) That significantly decreases the frequency of necessary waste disposal, thereby significantly saving work, time and cost in the maintenance and waste disposal process;

(2) That practically eliminates the chance or likelihood of waste overflowing said holder or tray and becoming compacted in crevices around said holder or tray, thereby saving the pet owner from having to bend over to brush clean the waste and likely incur unhygienic physical contact with waste material;

(3) That completely eliminates all need to physically remove and consequently touch the edge opening of said holder or tray, which may be contaminated with waste, thereby increasing health and hygiene in the disposal process;

(4) That significantly reduces the cost of maintenance by allowing the use of commonly available and relatively inexpensive plastic garbage bags to contain the waste instead of specialty holders or trays that typically cost over ten times as much as, thereby saving money; and;

(5) That establishes or motivates the establishment of an elevated litter box, thereby eliminating stress on and potential to the back, from bending, of the person maintaining the cat litter box.

### BRIEF DESCRIPTION OF THE SEVERAL VIEWS OF THE DRAWINGS

The drawings in FIGS. 1-6 are for purposes of illustrating the process in a preferred embodiment and should not be construed as a limitation on the invention itself.

FIG. 1 depicts a ‘Top View’ of the invention in the form of a platform or table with an intake opening designated as 12.

FIG. 2 is a ‘Bottom View’ of the invention depicted in FIG. 1 with an outflow opening designated as 14. Also shown are vertical support elements or legs 16a, 16b, 16c, and 16d.

FIG. 3 shows a ‘Side View’ of the invention depicted in FIG. 1 and FIG. 2 with a clamping or attaching mechanism, designated as 18, for attaching a garbage bag across said outflow opening 14.

FIG. 4 shows a collar or gasket 20 which may be positioned around said intake opening 12 so as to form a channel between said intake opening 12 and the bottom of said holder or tray.

FIG. 5 shows a ‘Side and Top View’ the invention substantially shaped in a form that can be substituted and positioned in the place and stead of said waste holder or tray. The intake opening apparatus is designated as 12 and the outflow opening is designated as 14. A clamping or attaching mechanism, designated as 18, for attaching a garbage bag across said outflow opening 14, is also shown.

FIG. 6 shows a ‘Side and Bottom View’ the invention substantially shaped in a form that can be substituted and positioned in the place and stead of said waste holder or tray. The intake opening apparatus is designated as 12 and the outflow opening is designated as 14. A clamping or attaching mechanism, designated as 18, for attaching a garbage bag across said outflow opening 14, is also shown.

### DETAILED DESCRIPTION OF THE INVENTION

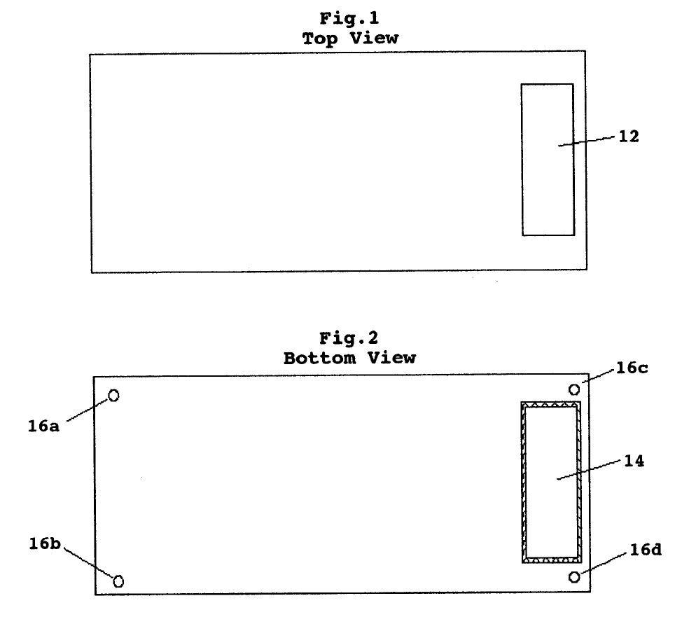

The drawings in FIGS. 1-6 are for purposes of illustrating the process and should not be construed as a limitation on the invention itself.

FIG. 1 depicts a ‘Top View’ of the invention in the form of a substantially rigid frame of suitable material shaped in the form of a platform or table that can be positioned wholly or partially beneath said litter box and said waste holder or tray. An intake opening is designated as 12.

FIG. 2 is a ‘Bottom View’ of the invention depicted in FIG. 1 with an outflow opening designated as 14. Also shown are vertical support elements or legs 16a, 16b, 16c, and 16d that allow the platform area of the apparatus to maintain a height distance above the floor or ground level.

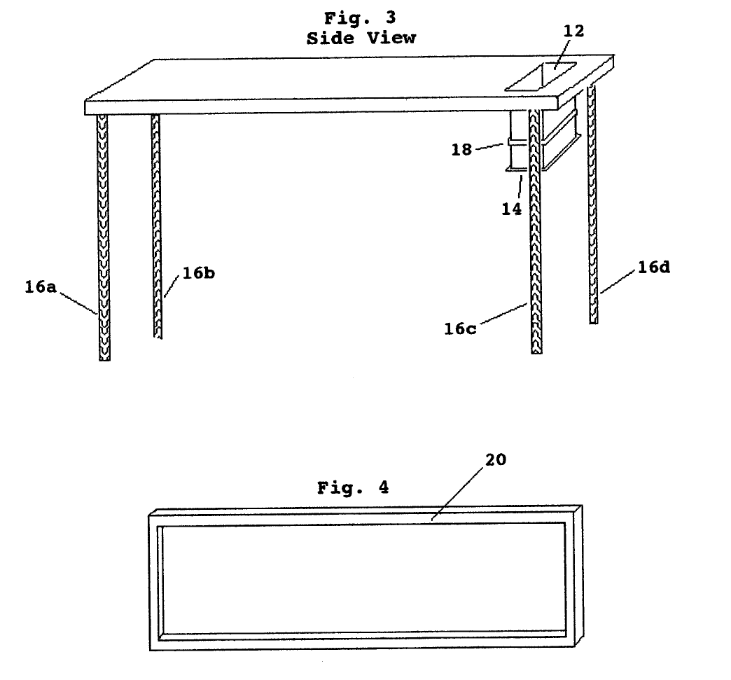

FIG. 3 shows a ‘Side View’ of the invention depicted in FIG. 1 and FIG. 2 with a clamping or attaching mechanism, designated as 18, for attaching a garbage bag across said outflow opening 14.

Said intake opening 12 is shown as a hole in the top of said platform or table that through to the bottom of said platform or table and said outflow opening 14. Said intake opening is intended to be position below said waste holder or tray so as to receive any waste passing out of a hole made in said holder or tray. The tray of one popular self-cleaning litter box presently in wide use is made from a thin plastic and, thereby, a hole may be easily cut into the bottom of said tray using common scissors. Also, the tray is held on a side of said litter box in a cavity that is has no bottom. Thereby any waste falling from a hole made in the bottom of said tray will fall freely from said tray into said intake opening 12 when said intake opening is positioned beneath said tray.

Attached to or following the outflow opening 14 is a clamping mechanism 18. It can be any clamping or suspension or coupling or attaching mechanism, as well as a portion frame member of said platform or table, that enables a container or plastic garbage bag to be clamped or hung or coupled or attached across said outflow opening. The clamping mechanism as depicted in FIG. 1 through FIG. 3 and FIG. 5 through FIG. 6 inclusive employs a collar like extension of the frame of the apparatus, around which the opening of a plastic garbage bag can be wrapped and coupled, and a rubber band or locking strap to clamp said bag to said collar.

When the apparatus is shaped in the form of a platform or table shape without any vertical supports or legs, the litter box must be placed upon a small table and the apparatus sandwiched between said litter box and said tabletop. The apparatus and litter box is then positioned slightly off the edge of the tabletop so that the outflow opening is clear of the surface of said tabletop, which placement also accomodates a garbage container or bag to be positioned or attached across said opening.

FIG. 4 shows a collar or gasket 20 which may be positioned around said intake opening 12 so as to form a channel between said intake opening 12 and the bottom of said holder or tray. Said collar or gasket need not be airtight and may be made from any suitable material including the same material as the platform or table frame of the apparatus. Said collar may be a separate unattached component or it may be an attached member or part of said platform or table.

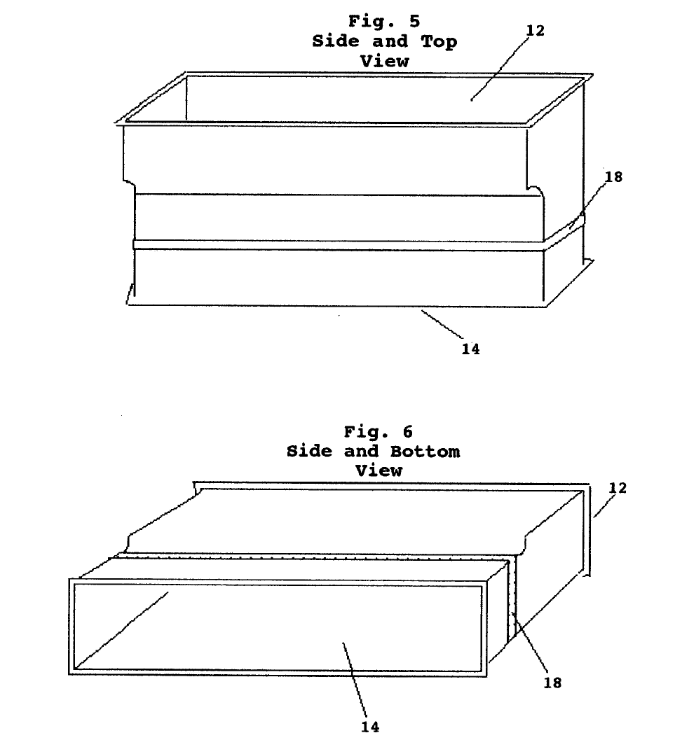

FIG. 5 depicts a ‘Side and Top View’ of the invention substantially shaped in a form that can be substituted and positioned in the place and stead of the said waste holder or tray. The intake opening apparatus is designated as 12 and the outflow opening is designated as 14. A clamping or attaching mechanism, designated as 18, for attaching a garbage bag across said outflow opening 14, is also shown.

FIG. 6 shows a ‘Side and Bottom View’ the invention as depicted in FIG. 5. The intake opening of the apparatus is designated as 12 and the outflow opening is designated as 14. A clamping or attaching mechanism, designated as 18, for attaching a garbage bag across said outflow opening 14, is also shown.

When the invention or frame of the apparatus is substantially shaped in a form that can be substituted and positioned in the place and stead of said waste holder or tray, said intake opening 12 functions similarly to the open end of the said holder or tray. However, unlike said holder or tray, said invention and apparatus includes an outflow opening 14 that may be formed to extend downward below the frame of said litter box. A disposable garbage container, such as a plastic garbage bag, can then be positioned across said outflow opening 14.

Attached to or following said outflow opening 14 as is depicted in FIG. 5 and FIG. 6 is a clamping mechanism 18. It can be any clamping or suspension or coupling or attaching mechanism, as well as a portion of the frame member of said apparatus, that enables a container or plastic garbage bag to be clamped or hung or coupled or attached across said outflow opening. The clamping mechanism as embodied in FIG. 1 through FIG. 3 and FIG. 5 through FIG. 6 inclusive employs a collar like frame extension, around which the opening of a plastic garbage bag can be wrapped and coupled, and a rubber band or locking strap to clamp said bag to said collar.

When the frame of the apparatus is substantially shaped in a form that can be substituted and positioned in the place and stead of said waste holder or tray, as depicted in FIG. 5 and FIG. 6, the litter box is placed atop a small table and positioned slightly off the edge of said table so that said outflow opening 14 is clear of the surface of said tabletop, and, so that a garbage container or bag may be positioned or attached across said opening.

A walk way or climb for the cat to ascend to the level of the litter box can be easily improvised, as cats are excellent natural climbers. In one embodiment of the invention includes such walk way or climb.

I claim:

1. An apparatus and method for use with a self-cleaning or self-raking cat litter box having a component waste holder or tray, comprising:
(a) A body frame that is substantially in the shape and form of a platform or table, that it can be positioned and fit wholly or partially beneath said litter box and said waste holder or tray, or that is substantially in the shape and form of said holder or tray so that it may be positioned or substituted in the place and stead of said holder or tray and,
(b) An intake opening means to receive waste deposited or falling into said intake opening and
(c) An outflow opening means to for any waste received by said apparatus to exit from said apparatus and,
(d) A channel or path between said intake opening and said outflow opening means for waste entering said intake opening to flow through said apparatus to said outflow opening.

2. The invention in claim said 1 that includes a clamping or suspension or coupling or attaching mechanism or frame member means to clamp or hang or couple or attach a container such as a plastic garbage bag across said outflow opening.

3. The invention in claim said 1 that when substantially in the shape and form of a platform or table also includes an interface collar or gasket type seal above said intake opening, means for creating a sealed or partially sealed passage way between said intake opening and any opening made in the holder or tray of said litter box.

4. The invention in claim said 1 that when substantially in the shape and form of a platform or table also includes vertical supports or legs, or the ability to attach said vertical supports or legs, means for the apparatus to support said litter box at a height distance above a surface, floor or ground level.

5. The invention in claim said 1 that when substantially in the shape and form of a platform or table also includes a walkway or climb means for the cat to walk or climb between ground or floor level and a height level of accessibility to the litter box.

6. The invention in claim said 1 when substantially in the shape and form of a platform or table also includes a functional enclosure around any container or bag attached or positioned below said outflow opening, means to conceal and/or contain said container or bag.
